(19) United States
(12) Patent Application Publication
(10) Pub. No.: US 2008/0115547 A1
(43) Pub. Date: May 22, 2008

(54) Quick release lock

(75) Inventor: Chin-Shu Chang, Changhua (TW)

Correspondence Address: BRUCE H. TROXELL, SUITE 1404, 5205 LEESBURG PIKE, FALLS CHURCH, VA, 22041, US

(73) Assignee: VULCAN SPORTS CO., LTD.

(21) Appl. No.: 11/603,041

(22) Filed: Nov. 22, 2006

(51) Int. Cl. E05B 71/00

(52) U.S. Cl. 70/233

(57) ABSTRACT

A quick release lock to facilitate smooth locking and unlocking operations includes a quick release apparatus and a linkage bar. The quick release apparatus includes a quick release handle, a sleeve, an actuation member and a lock. During locking and unlocking operations, the smooth characteristics of a latching bead is employed so that by turning and driving of the actuation bar, coupling with a slant trough of the quick release handle and guiding operation of a first bead trough of the linkage bar and a second bead trough of the sleeve, positioning and latching of the quick release handle can be controlled to prevent unauthorized opening of the quick release apparatus and achieve theft-proof effect.

### BACKGROUND OF THE INVENTION

1. Field of the Invention

The present invention relates to a quick release lock and particularly to a quick release lock to facilitate smooth locking and unlocking operations and provide theft-proof effect.

2. Description of the Prior Art

The general quick release apparatus can be removed quickly to change elements, thus are widely used on bicycles. Reference of conventional quick release apparatus are available in U.S. Pat. No. 4,621,873 (abbreviated case 1 hereinafter) and U.S. Pat. No. 4,724,692 (abbreviated case 2 hereinafter). Case 1 has a longitudinal pin inserting into a bore of an eccentric cylinder drive to control locking. It has a big drawback, namely if the handle is not being turned precisely to an anchored position the longitudinal pin cannot be smoothly inserted into the bore. This is especially true after the quick release apparatus has been used for a period of time and the wearing tolerance of elements increases. Locking operation becomes more difficult. Case 2 has a L-shaped cam member pressing a cam member to perform locking operation. It also has the same problem as the case 1, namely if the handle is not being turned accurately to the anchored position, or wearing tolerance of elements increase after use for a long period of time, locking operation becomes more difficult.

### SUMMARY OF THE INVENTION

In view of the aforesaid problems occurred to the conventional quick release apparatus, the present invention aims to provide a quick release lock that can perform locking and unlocking operations smoothly. It includes a quick release apparatus and a linkage bar. The quick release apparatus includes a quick release handle, a sleeve, an actuation member and a lock. During locking and unlocking operations, it employs smooth characteristics of a latching bead so that through turning and driving of the actuation bar, coupling with a slant trough of the quick release handle and guiding operation of a first bead trough of the linkage bar and a second bead trough of the sleeve, positioning and latching of the quick release handle can be controlled to prevent unauthorized opening of the quick release apparatus and achieve theft-proof effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a sectional view of the invention in an operating condition.

FIG. 4 is a sectional view of the invention in a locking condition.

FIG. 5 is a cross section taken on line I-I in FIG. 4.

FIG. 6 is a sectional view of the invention in a unlocking condition.

FIG. 7 is a cross section taken on line II-II in FIG. 6.

### DESCRIPTION OF THE PREFERRED EMBODIMENTS

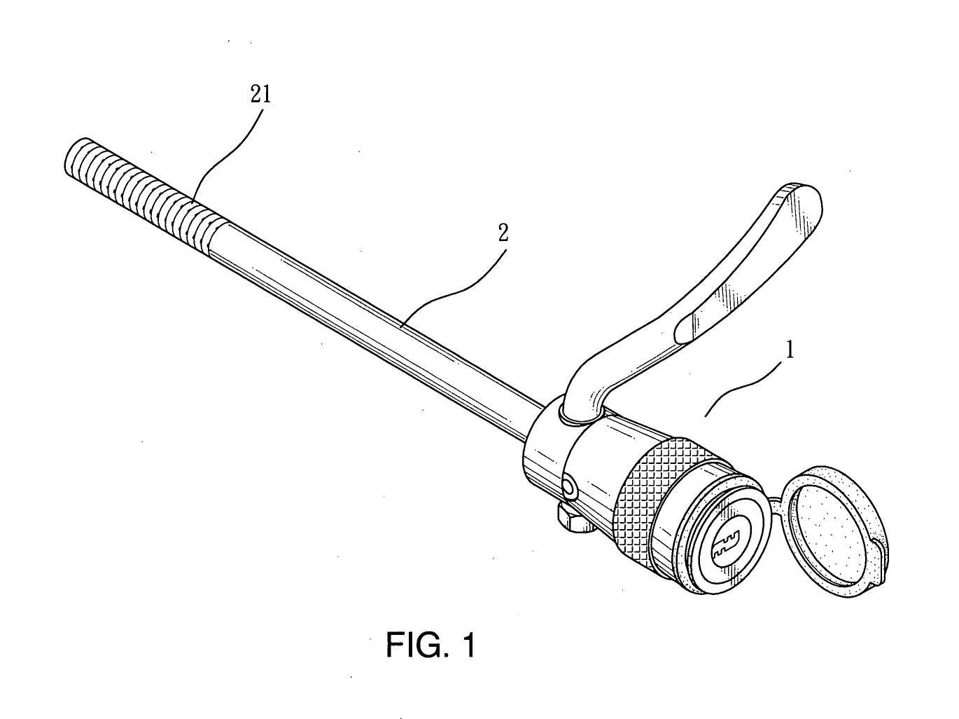

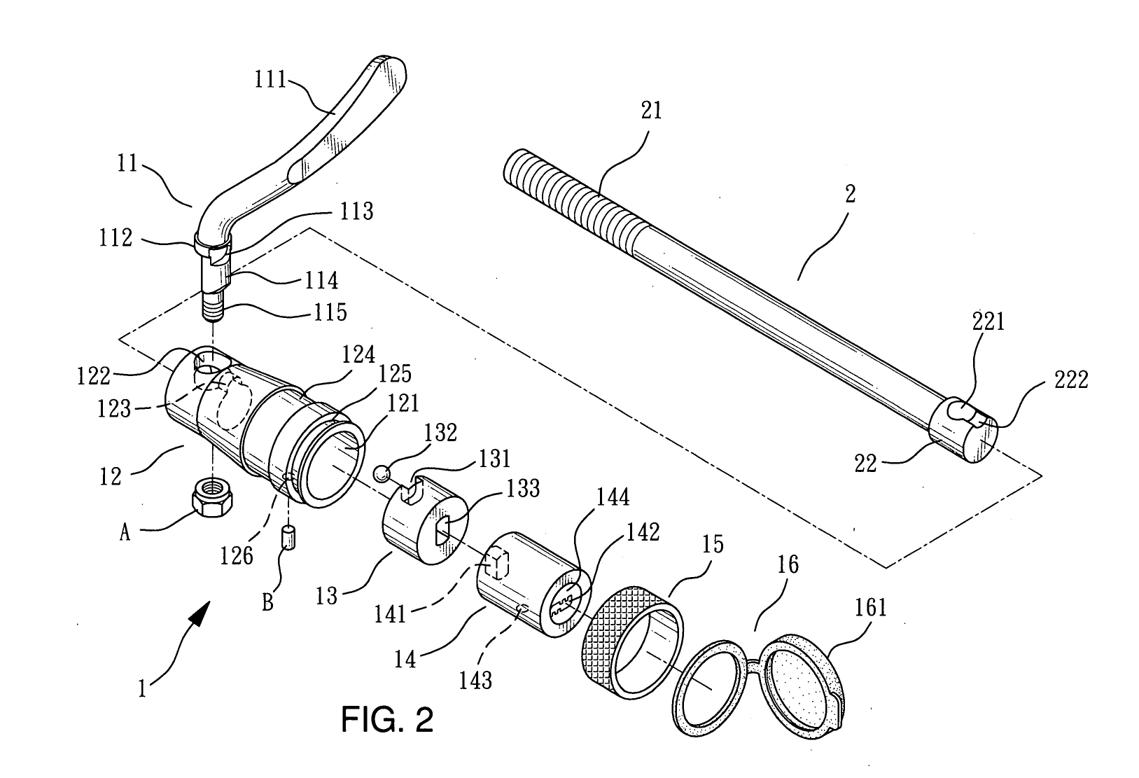

Referring to FIGS. 1 and 2, the quick release lock according to the invention includes a quick release apparatus 1 and a linkage bar 2.

The linkage bar 2 has a first threaded section 21 on one end and a bar seat 22 on other end. The bar sear 22 has a first through hole 221 and a first bead trough 222.

The quick release apparatus 1 includes:

a quick release handle 11 which has a handgrip 111, a bulged retaining ring 112 on a lower portion, a slant trough 113 on one side of the bulged retaining portion 112, an eccentric portion 114 extended beneath the bulged retaining portion and a second threaded section 115 on a lower end beneath the eccentric portion 114;

a sleeve 12 which has a housing chamber 121 that has a second through hole 122 formed on one side of a distal end to be inserted by the eccentric portion 114 fastened by a nut A. The second through hole 122 has a second bead trough 123 on one side. The sleeve 12 has a first pin hole 126 on the periphery, a first coupling zone 124 to couple with a coupling ring 15 and an annular groove 125 to be coupled with a coupling cap 16 which has a cap 161 extended from one side;

an actuation member 13 which is held in the housing chamber 121 and has a housing trough 131 on one end corresponding to the second bead trough 123 to hold a latching bead 132, and a bolt orifice 133 on another end; and

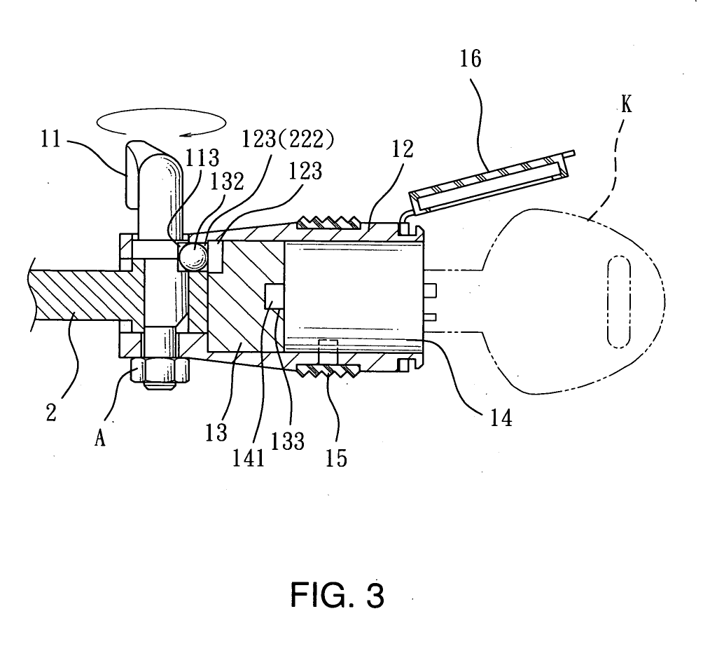

a lock 14 which has a cylinder 144 (details of the lock structure are known in the art and form no part of the invention, thus are omitted hereinafter), a bolt 141 on one end corresponding to the bolt orifice 133 and a keyway 142 on another end to receive a key K to turn the bolt 141 (referring to FIG. 3), and a second pin hole 143 corresponding to the first pin hole 126 to receive a pin B for fastening.

Referring to FIGS. 2 and 3, by means of the construction set forth above, the latching bead 132, actuation member 13, and lock 14 are placed into the housing chamber 121 through the front side of the sleeve 12, and are fastened by inserting the pin B into the first pin hole 126 of the sleeve 12 and the second pin hole 143 of the lock 14. The bar seat 22 of the linkage bar 2 is inserted into the sleeve 12 through other end to align the first through hole 221 with the second through hole 122; then insert the eccentric portion 114 of the quick release handle 11 and fasten a nut A to the second threaded section 115 to finish assembly.

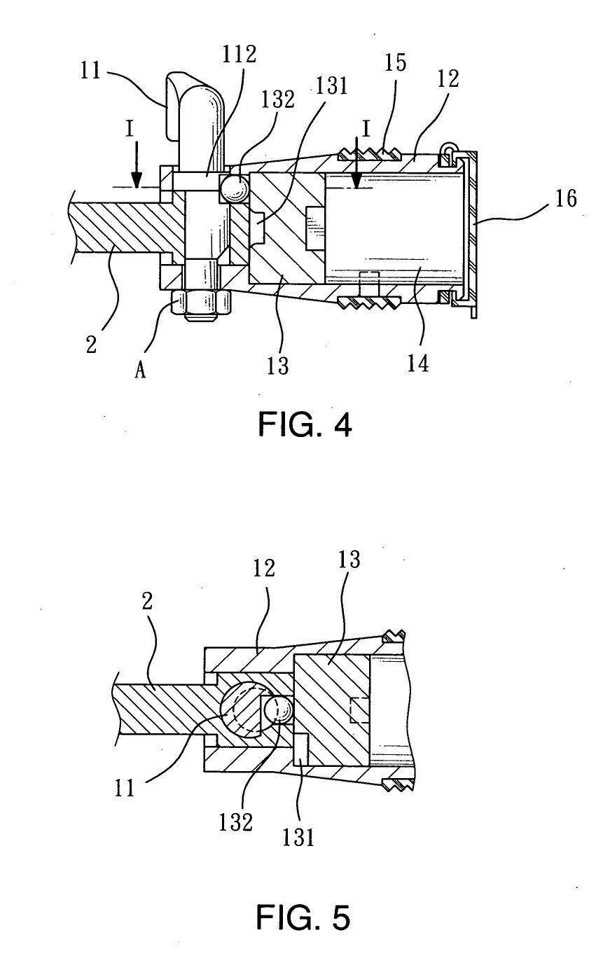

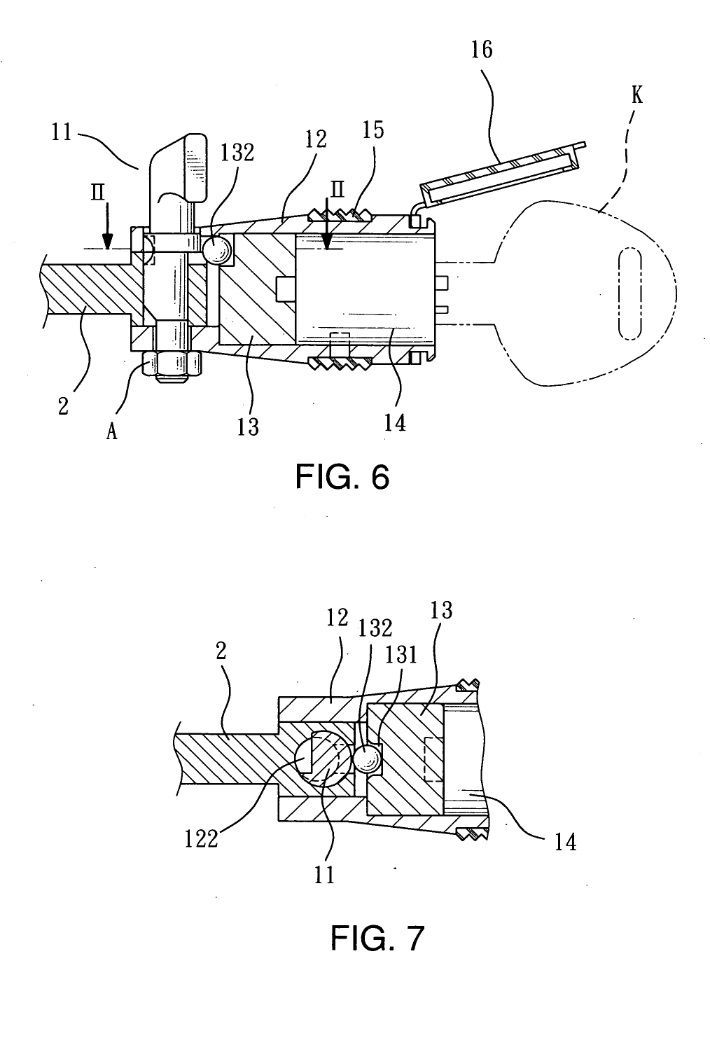

Referring to FIGS. 3, 4 and 5, when in use move the quick release handle 11 to a locking position, turn the key K to drive the cylinder 144 to the locking condition. The actuation member 13 is driven to urge the latching bead 132 into the slant trough 113, and the housing trough 131 of the actuation member 13 is turned to a non-aligned position with the second bead trough 123 of the sleeve 12. When the quick release handle 11 is moved, the latching bead 132 is driven into the first bead trough 222. As there is no moving space, the quick release handle 11 cannot be swiveled. Hence theft-proof effect can be achieved. During the locking process, as the latching bead 132 is round and smooth, even if the quick release handle 11 is not being moved precisely to the locking position, and a small tolerance or deviation occurs, a frication and traction take place between the latching bead 132 and the second bead trough 123 and slant trough 113 so that the locking condition can be accomplished as desired. Thus the positioning error that might otherwise occur to the quick release handle 11 can be overcome. To do unlocking operation, referring to FIGS. 6 and 7, insert the key K into the keyway 142 of the lock 14; turn the cylinder 144 to drive the bolt 141 to move the actuation member 13 to align the housing trough. 131 with the second bead trough 123 of the sleeve 12. Then the quick release handle 11 can be turned, and the latching bead 132 in the slant trough 113 is pushed and moved to the housing trough 131 of the actuation member 13 to free the quick release handle 11 from harnessing of the latching bead 132. Thus the quick release handle 11 can be swiveled as desired to change elements.

In short, the quick release lock of the invention does not affect the benefits of the quick release apparatus, and can enhance theft-proof function. It provides a significant improvement over the conventional techniques.

1. A quick release lock comprising a quick release apparatus and a linkage bar; wherein:
the linkage bar has a bar seat on one end which has a first through hole and a first bead trough formed thereon;
the quick release apparatus includes:
a quick release handle which has a handgrip, a bulged retaining ring on a lower portion, a slant trough on one side of the bulged retaining portion, and an eccentric portion extended from the bulged retaining portion;
a sleeve which has a housing chamber that has a second through hole formed on one side of a distal end to be inserted by the eccentric portion, the second through hold having a second bead trough one on side;
an actuation member which is held in the housing chamber and has a housing trough on one end corresponding to the second bead trough to hold a soherical latching bead, and a bolt orifice on another end; and
a lock which has a cylinder, a bolt on one end corresponding to the bolt orifice and a keyway on another end to receive a key to drive and turn the bolt.

2. The quick release lock of claim 1, wherein the linkage bar has a first threaded section on other end.

3. The quick release lock of claim 1, wherein the sleeve has a first coupling zone on the periphery to be coupled with a coupling ring.

4. The quick release lock of claim 1, wherein the sleeve has a second coupling zone on the periphery to be coupled with a coupling cap.

5. The quick release lock of claim 1, wherein the quick release handle has a second threaded section on a lower end beneath the eccentric portion.
